(19) United States
(12) Patent Application Publication
(10) Pub. No.: US 2010/0154620 A1
(43) Pub. Date: Jun. 24, 2010

(54) Optical Pickup for a Musical Instrument

(76) Inventors: Hans-Peter Loock, Kingston (CA); W. Scott Hopkins, Botley (GB); Jonathan Saari, Montreal (CA); Nicholas R. Trefiak, Ottawa (CA)

Correspondence Address: DOWELL & DOWELL P.C., 103 Oronoco St., Suite 220, Alexandria, VA, 22314, US

(21) Appl. No.: 12/579,785

(22) Filed: Oct. 15, 2009

Related U.S. Application Data
(60) Provisional application No. 61/105,624, filed on Oct. 15, 2008.

(51) Int. Cl. G10H 3/06

(52) U.S. Cl. 84/724

(57) ABSTRACT

This invention relates to an optical pickup for a musical instrument based on one or more than one Bragg grating. In one embodiment the optical pickup includes at least one Bragg grating in physical contact with a vibrating structure of the musical instrument so as to receive acoustic vibration associated with the musical instrument being played, such that a spectrum of the Bragg grating is modulated upon receipt of the acoustic vibration. A light signal reflected from the at least one Bragg grating may be amplified and the output may be directed to a loud speaker or other real-time output device. The output may also be directed to a data acquisition system for storage and further processing. The optical pickup may include two Bragg gratings arranged as an optical cavity.

### RELATED APPLICATIONS

This application claims the benefit of the filing date of U.S. Provisional Patent Application No. 61/105,624, filed Oct. 15, 2008, the contents of which are incorporated herein by reference in their entirety.

### FIELD OF THE INVENTION

This invention relates generally to an optical acoustic vibration sensor. In particular, this invention relates to an optical pickup for a musical instrument based on one or more optical waveguide Bragg grating.

### BACKGROUND OF THE INVENTION

Acoustic vibrations of musical instruments are conventionally sensed, for amplification and/or recording, using pickups, i.e., transducers that are sensitive to mechanical vibration in the acoustic frequency range (up to 20 kHz, or higher). Such sensors are typically piezoelectric devices that are placed on the soundboard or vibrating part of the instrument, or electromagnetic devices that are susceptible to the vibrations of strings and are placed near the strings. While a high-quality pickup may have a very flat acoustic frequency response, it nevertheless introduces an inertial mass to the soundboard, which can have a deleterious effect on the vibrations and hence the sound obtained. For example, piezoelectric pickups, which may be light and small enough to not have a substantial deleterious effect on the sound generated by a large instrument such as a guitar, are nevertheless unsuitable for use with small instruments such as flutes, recorders, and harmonicas, because of their size and mass. On the other hand, solid-body electric guitars and similar instruments are almost always equipped with electromagnetic pickups, which typically introduce considerable distortion of the sound obtained. In this case, however, the distortion of the sound by the pick-up may be a desired effect.

An optical pickup for a guitar was proposed by Hoag et al. in 1973 [1]. This pickup detected the motion of a shadow cast by a vibrating string onto a photodetector. Recently, there has been an attempt to incorporate a fiber optic waveguide into the string of a stringed instrument [2] and through the change in optical attenuation detect the strings' vibration. Both approaches are somewhat equivalent to a conventional electromagnetic coil pickup, in that the vibration of the string is transformed into the audio signal. Piezoelectric pick-ups, on the other hand, detect the vibration of the instrument's body and are, at least in principle, suitable for all musical instruments in which the instruments' vibration is indicative of the emitted sound, and not just string instruments.

### SUMMARY OF THE INVENTION

According to a first aspect there is provided an optical pickup for a musical instrument, comprising: at least one Bragg grating in physical contact with a vibrating structure of the musical instrument so as to receive acoustic vibration associated with the musical instrument being played; wherein a spectrum of the Bragg grating is modulated upon receipt of the acoustic vibration. The at least one Bragg grating may have a grating selected from constant pitch, chirped, blazed, and π-shifted. The Bragg grating may be disposed in an optical fiber. The optical fiber may be a single mode optical fiber.

In one embodiment, the optical pickup may include two or more Bragg gratings. A response from at least one Bragg grating may be biased optically and/or electronically.

In another embodiment, the optical pickup may include two Bragg gratings arranged as an optical cavity. The two Bragg gratings may be substantially identical.

According to a second aspect there is provided an optical pickup system for a musical instrument, comprising: at least one Bragg grating in physical contact with a vibrating structure of the musical instrument so as to receive acoustic vibration associated with the musical instrument being played; a light source that produces light for use with the Bragg grating; and means for detecting modulation of a spectrum of the light by the Bragg grating upon receipt of the acoustic vibration. The at least one Bragg grating may have a grating selected from constant pitch, chirped, blazed, and π-shifted. The means for detecting modulation of a spectrum of the light by the Bragg grating may measure at least one of intensity of reflected or transmitted light at a fixed wavelength, and shift of the peak reflection wavelength. The means for detecting modulation of a spectrum of the Bragg grating may be a photodetector.

In one embodiment, the system may include two or more Bragg gratings. A response from at least one Bragg grating may be biased optically and/or electronically. The two or more Bragg gratings may be interrogated sequentially or simultaneously.

In another embodiment, the at least one Bragg grating may be disposed in an optical fiber. The optical fiber may be a single mode optical fiber.

In another embodiment, the system may include two Bragg gratings arranged as an optical cavity. The two Bragg gratings may be substantially identical.

According to a third aspect there is provided a method for an optical pickup for a musical instrument, comprising: disposing at least one Bragg grating in physical contact with a vibrating structure of the musical instrument so as to receive acoustic vibration associated with the musical instrument being played; launching light into the Bragg grating; and detecting modulation of a spectrum of the light by the Bragg grating upon receipt of the acoustic vibration. The at least one Bragg grating may have a grating selected from constant pitch, chirped, blazed, and π-shifted. The method may include manipulating a response from at least one Bragg grating through electronic and/or optical biasing.

In one embodiment, detecting may include detecting at least one of intensity of reflected (or transmitted) light at a fixed wavelength, and shift of the peak reflection wavelength. Detecting may include using a photodetector.

In another embodiment, the method may include disposing two or more Bragg gratings on the musical instrument. The method may include interrogating the two or more Bragg gratings sequentially or simultaneously.

In another embodiment, the method may include disposing two Bragg gratings arranged as an optical cavity. The method may further include disposing two substantially identical Bragg gratings arranged as an optical cavity.

### BRIEF DESCRIPTION OF THE DRAWINGS

For a better understanding of the invention, and to show more clearly how it may be carried into effect, embodiments of the invention will be described below, by way of example, with reference to the accompanying drawings, wherein:

FIG. 1A shows schematically a Bragg grating (FBG) affixed to a vibrating structure in its rest position (a) and stretched with respect to its rest position at the maximum of an acoustic vibration cycle (b). The associated graph shows the respective reflectance spectra at the rest position (a) and at the maximum amplitude of vibration (b). The plot shows the change in optical reflectance at the midreflection point (circle), when the FBG is stretched and compressed due to vibration.

FIG. 1B is a graph showing the respective transmission spectra at the rest position (a) and at the maximum amplitude of vibration (b). The graph shows the change in optical transmission, i.e., attenuation at the midreflection point (circle), when the FBG is stretched and compressed due to vibration.

FIG. 1C shows schematically a FBG cavity affixed to a vibrating structure in its rest position (a) and stretched with respect to its rest position at the maximum of an acoustic vibration cycle (b). The associated graph shows the respective reflectance spectra at the rest position (a) and at the maximum amplitude of vibration (b). The graph shows the change in optical reflectance at the midreflection point (circle), when the FBG is cavity stretched and compressed due to vibration.

FIG. 1D is a block diagram showing optical and electronic components of a setup for an optical pickup as described herein, where electrical connections are shown in dashed lines.

FIG. 2A shows the transmission spectrum of a wideband FBG (top trace) and the laser emission spectrum of a moderately tunable distributed feedback laser diode light source (bottom trace). FIG. 2B shows the transmission spectrum of a narrow band FBG (top trace) and the laser emission spectrum of a widely tunable laser diode light source.

FIG. 3A shows the amplitude spectrum of the plucked E₄ string of an acoustic guitar recorded using a narrowband FBG (lower trace) and using a piezoelectric (PZT) pickup (upper trace) simultaneously through the two different stereo channels. The traces are offset vertically for clarity. FIG. 3B shows Fourier transforms of the two recordings.

FIG. 4 shows frequency spectra of two sound recordings of six plucked strings of an acoustic guitar. The traces from bottom to top correspond to recordings made with a narrowband FBG pickup and a condenser microphone (recorded simultaneously), and the narrowband FBG pickup and the piezoelectric pickup (also recorded simultaneously).

FIG. 5A shows the frequency spectrum of a plucked E₄ string of an acoustic guitar recorded with a FBG pickup. FIGS. 5B and 5C show the frequency response for the FBG pickup mounted at eight positions from 2 cm to 16 cm below the bridge of the guitar, using a distributed-feedback (DFB) laser diode (FIG. 5B) and a tunable laser diode (FIG. 5C).

FIG. 6A shows a sound recording of a plucked E₄ string of a solid body electric guitar using a narrowband FBG pickup (lower trace) and singe coil magnetic (upper trace; offset vertically for clarity). FIG. 6B shows a Fourier transform of the waveform of FIG. 6A.

FIG. 7A shows the reflectance spectrum of an optical cavity consisting of two substantially identical FBGs placed 10 mm apart in a single mode fiber. FIG. 7B shows a portion of this spectrum together with the emission spectrum of tunable, distributed-feedback-laser light source at 1542.14 nm.

FIG. 8 shows the amplitude spectrum of the plucked E₄ string of an acoustic guitar, recorded using an FBG cavity (upper trace) and a piezoelectric pickup (PZT; lower trace).

FIG. 8B shows the Fourier transform of this recording (FBG, upper trace; PZT, lower trace).

### DETAILED DESCRIPTION OF EMBODIMENTS

A Bragg grating is a periodic modulation of refractive index along the core of an optical waveguide, such as, for example, an optical fiber. Light guided by the fiber is reflected by the Bragg grating when the wavelength λ of the light guided by the core of the fiber matches the Bragg wavelength λ_{B}=2 nA, where n is the effective refractive index of the guided mode and λ is the period of the grating [3]. Any parameter that changes λ or n leads to a change in the Bragg grating's reflection spectrum. Such parameters include, but are not limited to physical stimuli (e.g., stretching or straining the Bragg grating, by, for example, acoustic vibrations), and thermal stimuli (e.g., thermal expansion or contraction). For example, the period may be changed by stretching the Bragg grating, whereas the refractive index may be changed by straining the grating.

Optical fiber Bragg gratings (FBGs) are used in mechanical sensors in medical, construction, chemical, nuclear, aerospace, and military industries. For example, FBGs are used as transducers for ultrasound measurements [4,5,6], and in ultrasound hydrophones [7], and may be used to record photoacoustic signals [8]. In these applications the wide frequency response range of FBGs, from DC (static strain) to over 45 MHz, may be beneficial.

According to a broad aspect there is provided herein an optical sensor for low frequency vibration based on a Bragg grating. The term “low frequency”, as used herein, refers to frequency in the range of up to about 50 kHz.

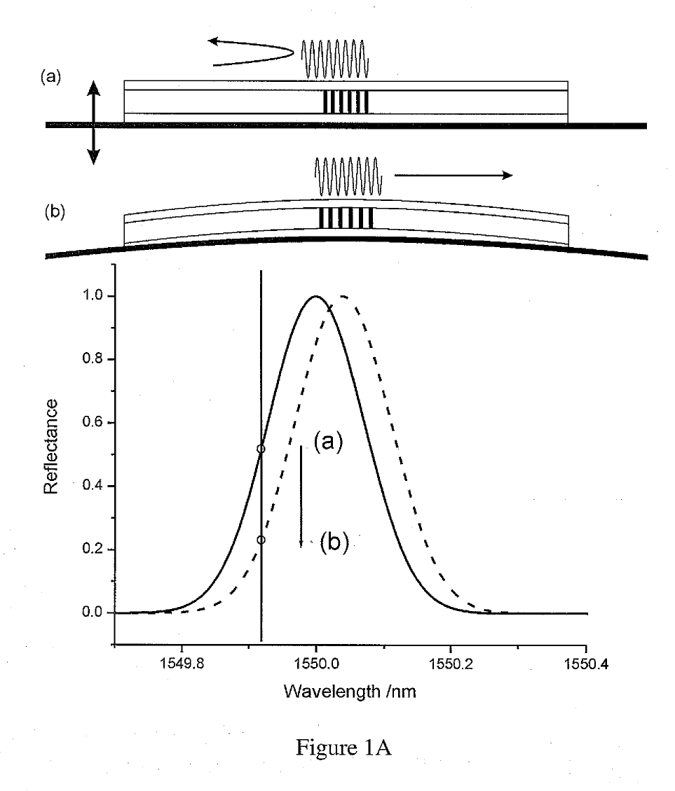

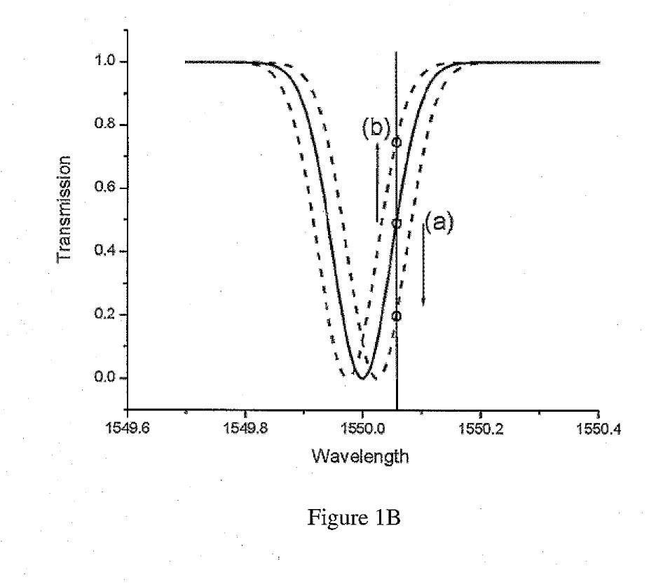

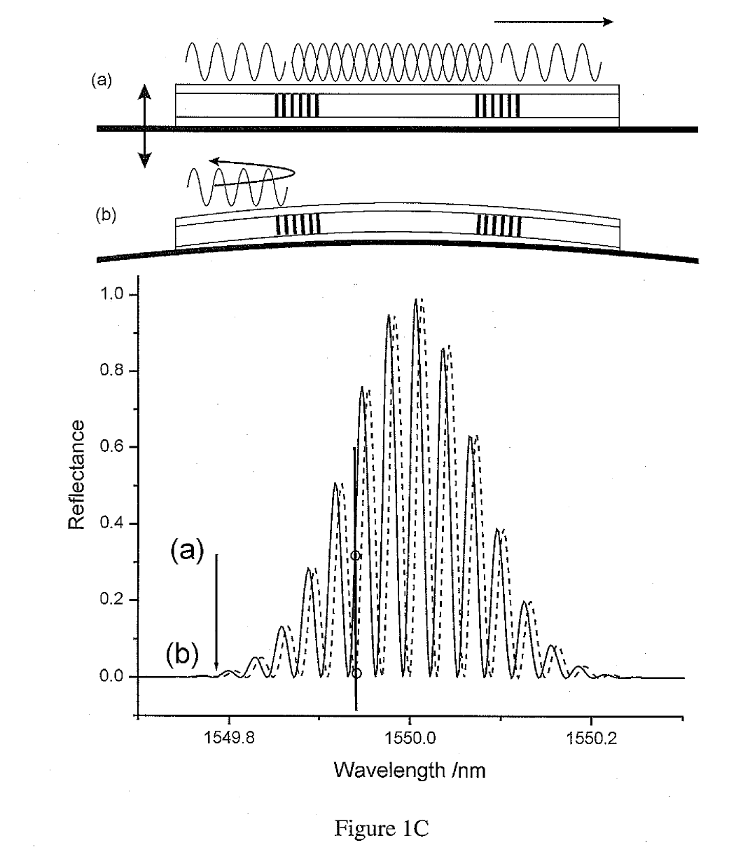

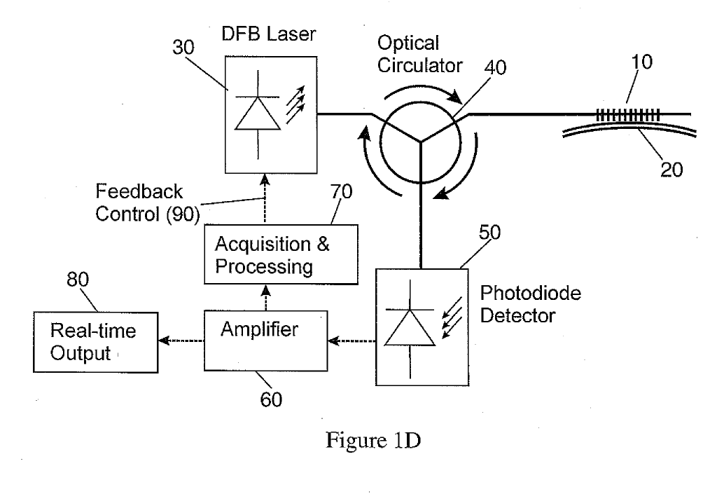

The sensor includes at least one Bragg grating. In use, the sensor is disposed in physical contact with a structure associated with the low frequency vibration so as to receive the vibration. When light is applied to the Bragg grating, a reflection or transmission spectrum of the Bragg grating is modulated upon receipt of the low frequency vibration. The modulation of the reflection or transmission spectrum of the Bragg grating may be detected to obtain information about the vibration. The Bragg grating may be disposed in any type of optical waveguide as may be appropriate for a given application, such as an optical fiber, including, for example, a single mode optical fiber, or a waveguide prepared in glass or plastic materials using techniques such as laser writing [9,10], micro-molding [11], nano imprinting [12], and lithographic methods [13,14]. The common feature of a Bragg grating used as described herein is the ability to reflect light in a narrow spectral region around the Bragg wavelength λ_{B} given by the refractive index, n, and the periodicity of the grating, A. In such a Bragg grating, the peak of the reflection spectrum shifts when the grating is deformed (e.g., stretched, compressed, or bent), i.e. when the grating is affixed to a vibrating structure (see, e.g., FIGS. 1A, 1B, 1C).

In one embodiment, the sensor is a pickup for a musical instrument. In this embodiment, the Bragg grating, which may be in an optical fiber, such as a single mode optical fiber, senses acoustic vibrations of the musical instrument. The term “acoustic vibration” as used herein refers to vibrations in the frequency range that is generally considered to be within the range of human hearing, that is, up to about 20 kHz.

For sensing acoustic vibrations, the broad acoustic frequency response of a Bragg grating compares favourably to that of piezoelectric devices which have a typical response of up to 12-15 kHz, and that of electromagnetic pickups which have a frequency response of about 200 Hz to about 10 kHz, with a sharp drop off at about 4-5 kHz. Bragg gratings are insensitive to electrical interference (such as RF noise) and can easily be shielded against optical interference, and do not produce or react to a magnetic field. Also, single mode optical fibers in which FBGs may be disposed are light-weight and flexible, and therefore are free of mechanical eigenfrequencies in the audible range. One or more Bragg grating pickups as described herein may be used in combination with a piezoelectric pickup or an electromagnetic pickup.

In this embodiment, the Bragg grating of the sensor is disposed on the musical instrument so as to be in direct physical contact with a vibrating structure of the instrument. As used herein, the term “vibrating structure” refers to at least a part of a musical instrument that exhibits vibrations (i.e., resonates) when the instrument is played. The vibrating structure may also be referred to as a resonating body. The vibrating structure of the instrument is part of a primary source of the sound generated by the instrument. That is, the acoustic vibrations are set up in the vibrating structure when the instrument is played, rather than being secondarily induced by sound waves incident upon the vibrating structure. In this regard, it is noted that the optical pickup may be used in environments where sound waves cannot propagate (e.g., in a vacuum).

The musical instrument may be any instrument that exhibits a vibrating structure when played. For some instruments, only a part of the instrument may exhibit a vibrating structure (such as the bridge or head stock of a solid-body string instrument). For other instruments, all or most of the instrument may exhibit a vibrating structure (such as an acoustic guitar or percussion instrument). Instruments that use reeds (e.g., woodwinds) or resonating air columns (e.g., flutes, brass instruments) to generate sound also exhibit vibrating structures and accordingly Bragg grating pickups may also be used with such instruments.

The Bragg grating reflection or transmission spectrum changes in response to the vibrations of the vibrating structure of the musical instrument. This is shown schematically in FIG. 1A, where a FBG disposed on a vibrating structure is shown in its rest position (a) and stretched with respect to its rest position at the maximum of an acoustic vibration cycle (b). The plot of FIG. 1C shows the respective transmission spectra at the rest position (a) and at the maximum amplitude of vibration (b). The plot shows the change in attenuation at the midreflection point (circle) when the FBG is stretched and compressed due to the vibrations.

FIG. 1D shows an embodiment of a setup for an optical pickup system as described herein. The pickup includes a Bragg grating or a Bragg grating optical cavity 10 which was attached to a vibrating structure of a musical instrument 20. A light signal from a source such as a DFB laser 30 was guided to the pickup 10 through an optical circulator 40. Light reflected from the pickup was directed to a photodetector 50 via the same optical circulator 40. The output from the photodetector was amplified by an audio amplifier 60. The amplified output may be directed to a speaker or another real-time output device 80. It may also be directed to a data acquisition system 70 for storage and further processing. In some applications, such as frequency modulation spectroscopy and tracking of the reflection peak, which are described herein, the processed data may be used for feedback control 90 of the laser wavelength, intensity, or modulation.

It will be appreciated that an optical pickup as described herein is not limited to use with a musical instrument. That is, such a pickup may be used with any device, apparatus, or organism that exhibits a vibrating structure associated with acoustic vibrations, insofar as it may be desirable to obtain, amplify, record, etc., the acoustic vibrations. For example, the throat of a person speaking or singing is a vibrating structure, and an FBG pickup in contact with the throat may be used to record the person's voice.

Features of an FBG pickup include very low mass, no requirement for parts made of ferromagnetic materials, insensitivity to electro-magnetic interference, and broad frequency response. One, two, or many FBG pickups may be disposed onto a single musical instrument without negatively affecting each other, the instrument, or the acoustic vibrations of the instrument. The ability to dispose many FBG pickups on a musical instrument, and on different areas the instrument, gives a substantial level of control over the sound of the instrument.

An FBG optical pickup may be embedded into the vibrating structure of the musical instrument, affixed to the surface of a vibrating structure of the instrument, and/or may form part of the instrument or vibrating structure either permanently or temporarily (e.g., removably). The FBG pickup may be used with a broadband or narrowband light source, and one or more photodetectors suitable for measuring the change of at least part of the spectrum of the FBG in real time. The modulation of the refractive index in the FBG may have a constant pitch, be chirped [15,16], blazed [37], or be π-shifted. [17,18,19,20].

The Bragg grating may be interrogated by any method known in the art. Such methods include methods for strain sensing using a Bragg grating and may include, for example, time-dependent measurement of intensity of reflected (or transmitted) light at a fixed wavelength, such as the wavelength at the mid-reflection point [21,22,23,8]. In this case the Bragg grating may form part of a system that may include further Bragg gratings as filters [24]. One of many alternative interrogation schemes that may be employed involves the measurement of the shift of the peak reflection wavelength by, e.g., interferometric methods [25,26,27], or by a frequency modulation method [28,29].

As noted above, two or more Bragg gratings may be used for an optical pickup for a musical instrument, using multiplexing techniques. Where multiple Bragg gratings are used, each grating may provide a different response for a given action on the instrument according to, for example, its position on the instrument, the optical properties of the grating, and/or electronic and/or optical biasing of the signal from a grating with respect to that of another Bragg grating. Such biasing may include electronic manipulation of the signal (e.g., attenuation, amplification, frequency filtering, etc.) and/or optical manipulation (e.g., attenuation, interrogation wavelength, etc.). The two or more Bragg gratings may be interrogated simultaneously or sequentially and their responses processed separately or together. When processed separately before being mixed into an audio recording (e.g., with adjustable bias), one can control the sound of the recording to a high degree. On the other hand one may expect that optical and electrical schemes that combine the output from different Bragg gratings into a single recording channel at constant relative bias may be simpler and less expensive [30,31,32].

For example, each Bragg grating may have a different reflection spectrum, and the two or more Bragg gratings may be provided in one waveguide, or each individually in a waveguide, or in combinations of Bragg gratings in two or more waveguides. The Bragg gratings may be interrogated simultaneously, or sequentially, or in combinations. Their responses may be probed using either a broadband source combined with a detector array that is capable of resolving attenuation peak shifts for each Bragg grating independently, or using many narrow width light sources each set to interrogate one Bragg grating [31]. The Bragg gratings may also be interrogated sequentially using a tunable light source [33]. The two or more Bragg gratings may also have identical reflection spectra and be interrogated by a single narrowband light source [30]. In this case the light transmitted or reflected from the Bragg gratings may be combined into a single detector. Biasing against some of the Bragg gratings may be provided, when attenuating the light transmitted through the respective waveguides.

The two or more Bragg gratings may be combined into an array. For example, when the transmitted or reflected output is coupled into a detector array, the relative contribution of each Bragg grating may be biased using differential attenuation of the optical signal, or regulation (amplification or attenuation) of the electrical signal from the photodetector.

The light source used for interrogation may have a narrow bandwidth compared to the Bragg grating spectrum, or a bandwidth broader than that of the Bragg grating spectrum. The light source may be intensity-modulated to exhibit sidebands, thus allowing for phase sensitive detection.

In another embodiment the Bragg grating may form part of an optical cavity of two Bragg gratings and the cavity finesse may be monitored as a measure for optical loss in the cavity [34,35]. The two Bragg gratings may be substantially identical, such that, for example, they have overlapping reflection spectrums. As used herein, the term “substantially identical” means that one or more optical characteristics (e.g., amplitude of reflectivity, wavelength of maximum reflectivity, width of the reflection spectrum, slope of the reflection spectrum, etc.) of the two Bragg gratings are the same, or as close to being the same as may be achieved using current fabrication techniques. This measurement may be done in different ways including, for example, measuring the cavity ring-down time, or measuring the phase shift of the light emitted from the cavity with respect to the light entering the cavity. Optical lifetime measurements may be used to characterize the finesse of optical cavities. Lifetime may be measured in at least two ways: (1) through injection of a light pulse into the cavity and monitoring the build-up and/or ring-down of the cavity: or (2) by measuring the phase shift that continuous wave, intensity modulated light experiences when coupled into the cavity (i.e., phase shiftcavity ring-down). Both methods have been employed with non-resonant cavities, i.e., when FBGs were spaced so far apart that the cavity spectrum has a free spectral range that is small compared to the optical band width of the injected light.

In another embodiment the FBGs that form the cavity may be spaced close enough that the free-spectral range is larger than the band width of the injected light, such that distinct longitudinal cavity modes are observed. These modes may be used for acoustic vibration measurements in two ways: (1) by measuring the optical loss that a cavity mode experiences, which depends on the finesse of the cavity, which in turn depends on the distortion that either the cavity experiences or one of the FBGs experiences; and (2) by measuring the wavelength position of the fringes, which depend strongly on the length and strain of the cavity, both of which are altered when the cavity is affixed to a vibrating structure of a musical instrument. With respect to interrogation, the cavity formed by two substantially identical FBGs behaves similar to a single FBG. Both acoustic transducers show a reflection and transmission spectrum that is sensitive to the vibration of the musical instrument, i.e., the wavelengths of the peaks in the spectrum shift as the instrument body vibrates. In both cases information about vibration amplitude and frequency (i.e., the audio information) may be obtained by, for example, measuring intensity changes at a fixed wavelength (e.g., the mid-reflection point), or by measuring the shift of the peak wavelength.

Embodiments are further described by way of the following non-limiting Working Examples.

### Working Example 1

### Single FBG Transducer

Optical pickups for an acoustic guitar and for a solid-body electric guitar were made using single FBGs. A tunable laser was used as a light source and a photodetector was used to measure the transmitted light. The detector output was fed directly into a mixing console and sampled by a soundcard. Alternative schemes for interrogating the FBG may be used as described above.

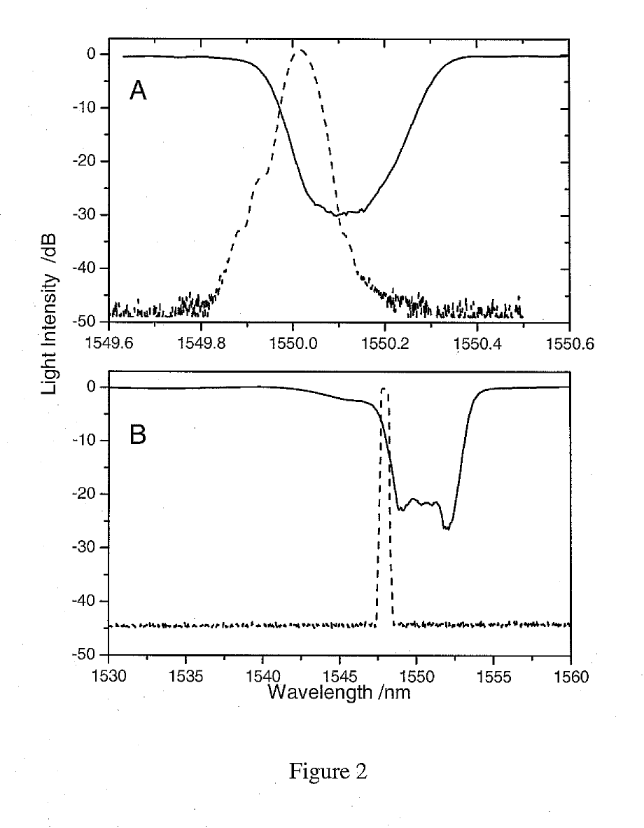

Two different commercial FBGs (Avensys Labs, Montreal, QC), each with ˜30 dB attenuation, were used as acoustic vibration sensors for two optical pickups. The FBGs had reflection bandwidths of 1.5 nm and 0.2 nm (FIGS. 2A and 2B, respectively). The sensitivity of the response depended on the slope of the attenuation spectrum near the midreflection point and was lower for the wide bandwidth FBG (0.017 dB/pm) compared to the narrow bandwidth FBG (0.26 dB/pm).

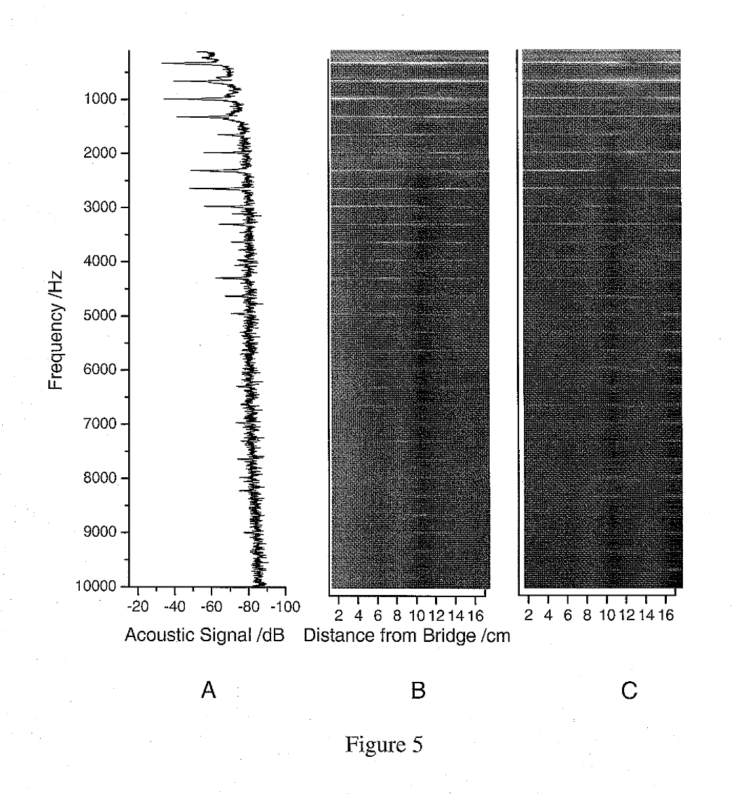

Three different single mode diode lasers were used to interrogate the two FBGs. The lasers were tuned to the short wavelength edge of the respective reflection spectrum. A tunable telecom diode laser, TDL (ANDO, 200 MHz bandwidth) was used with both the broadband and narrowband FBGs. A less expensive and more compact fiber coupled laser diode (LPS-1550-FC, Thorlabs) was used with the narrowband FBG only. The laser could be feedback-stabilized by using a second FBG which was identical to that attached to the guitar. The output spectrum then demonstrated single mode operation with minimal “mode hops”, helpful to reduce noise in the system. A third, distributed-feedback (DFB) laser diode (AC5900, Archcom Technologies) was used for the measurements presented herein. A laser driver board (Thorlabs, ITC102) was used to set the wavelength through temperature and current control. The measurements indicated that the DFB laser diode and the TDL had very similar response characteristics, indicating that the choice of light source does not influence the quality of the sound recordings (see, e.g., FIG. 5). Also, little difference was found in the recordings made with the narrowband and wideband FBGs.

The change in transmission was monitored using an in GaAs photodetector (DET10C, Thorlabs, 10 ns rise/fall time). The photodetector output fed into a mixing board (Alto S-8 Analogue) before being digitized by a soundcard (SoundMax) of an ASUS motherboard.

The experimental setup was substantially as shown in FIG. 1D. The FBGs were fixed to the hollow-body acoustic guitar (Takamine 540C) and the solid-body electric guitar (Squier, Standard Stratocaster) using adhesive tape. The FBGs were placed in different positions on both guitars. For each guitar, transmission through the FBG was recorded simultaneously on one channel of the stereo mixing board, while the other channel recorded either the output of a condenser microphone (Samson C01 Studio), or that of a preamplified high-quality piezoelectric (PZT) pickup built into the acoustic guitar (Takamine TK4N), or that of the magnetic pickup of the electric guitar (single coil, AlNiCo, model unknown).

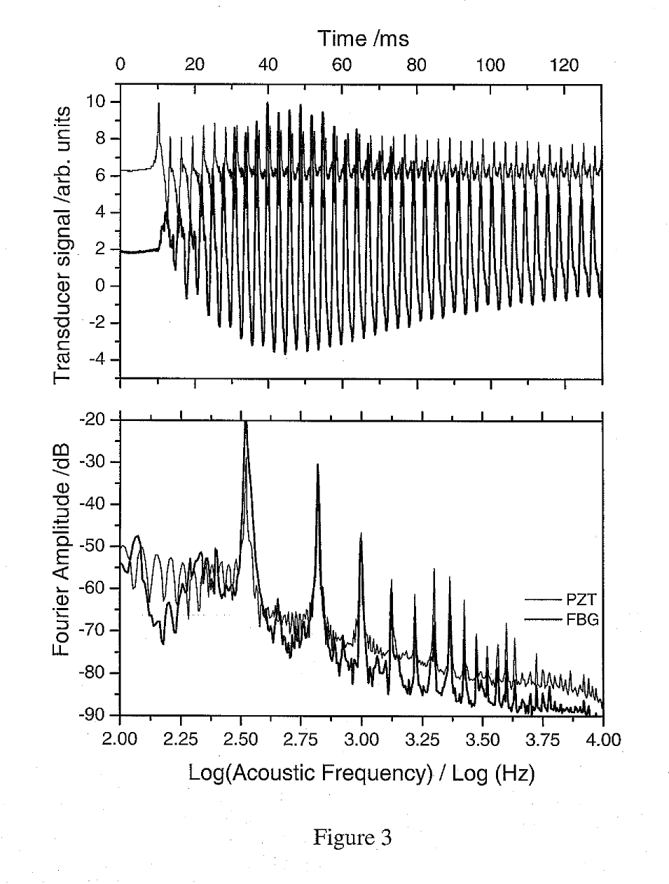

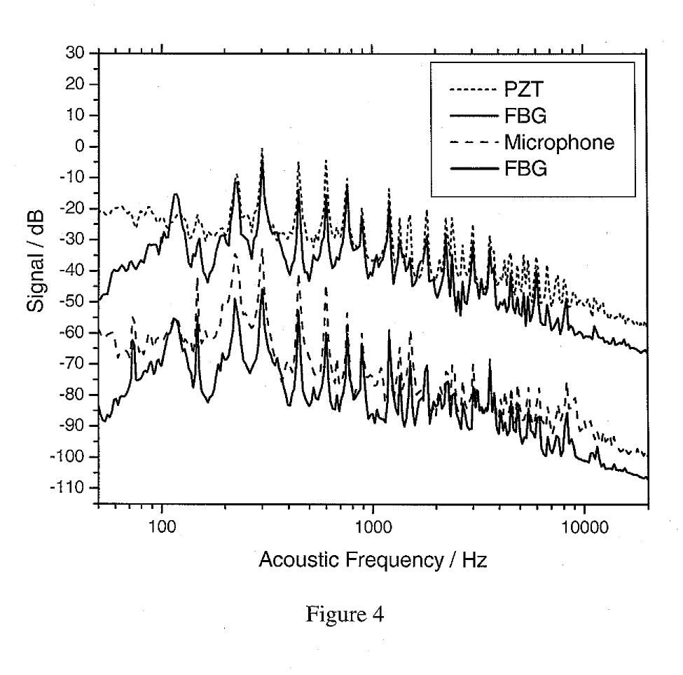

Comparison of the narrowband FBG optical pickup to the three conventional recording methods (condenser microphone, piezoelectric pickup, magnetic induction coil pickup) was carried out. FIG. 3A shows the amplitude spectrum of the plucked E₄ string of the acoustic guitar recorded by the FBG (lower trace) and by the PZT (upper trace) through the two different stereo channels. The traces are offset vertically for clarity. The recordings exhibit a high degree of correlation which is even more apparent when the Fourier transforms of these two recordings are compared (FIG. 3B). The frequency analysis shows a good correlation from the fundamental acoustic frequency at about 333 Hz to the 12^{th} overtone at 4320 Hz. Recordings with all six plucked strings were made using the narrowband FBG on one channel and either the PZT or the microphone on the other channel. Again the Fourier transforms revealed a high degree of correlation up to frequencies of about 0.12 kHz (FIG. 4). Differences in the waveforms, particularly with regard to the relative intensities are readily attributed to the different positions at which the PZT and FBG were placed. The microphone was more sensitive to ambient noise and showed a noticeable signal below 100 Hz, probably due to cooling fans of the equipment (data not shown).

As expected, the frequency response spectrum of the narrow band FBG pickup was somewhat dependent on its position on the guitar. FIG. 5 shows the frequency spectra obtained as above by plucking the E₄ string, for different positions of the narrowband FBG pickup, using the DFB laser and the TDL laser as light sources. The distance of the FBG pickup from the bridge of the acoustic guitar was varied in eight steps from 2 cm to 16 cm. FIG. 5 shows that the frequency response does not depend strongly on which laser was used, but that the relative frequency contributions are different for the different positions of the pickup on the guitar. This is likely due to the existence of nodal lines on the sound plate of the acoustic guitar.

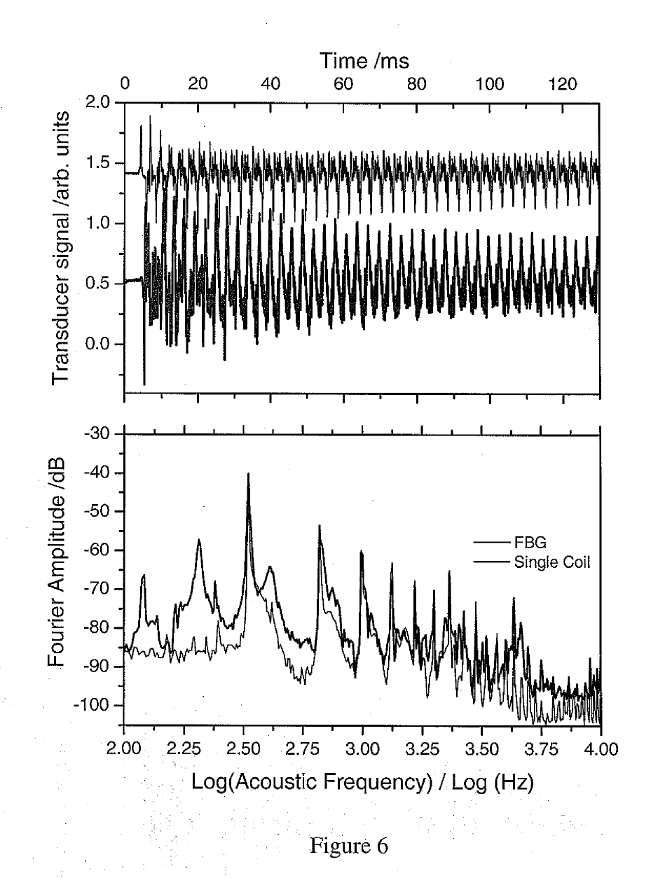

For the solid-body electric guitar, a comparison of the single coil magnetic induction pickup with the FBG pickup placed on the headstock of the guitar shows a marked difference in both the waveforms (FIG. 6A) and in their Fourier transforms (FIG. 6B). Of course, the mechanisms for signal transduction are substantially different for these two pickups and such differences in the recordings are expected. The magnetic pickup was more sensitive to the string vibrations and less to the vibration of the guitar body, whereas the FBG mounted on the headstock translated the vibrating motion of the neck upon plucking the strings into the audio signal. A comparison of the audio recordings obtained using both pickups illustrates that the magnetic pickup produces the characteristic high-pitched, slightly distorted sound of an electric guitar, whereas the FBG produces a sound resembling a semi-acoustic guitar. Accordingly, the frequency spectrum using the FBG pickup (FIG. 6B) showed strong acoustic signals from the fundamental vibration at 329 Hz to its 20^{th} overtone at 6600 Hz, but also contributions from near resonant vibrations of the other strings at about 118 Hz (A₂), and near 208 Hz (G₃) from which the E₄ frequency at 329 Hz may be synthesized. The single coil pickup was not sensitive to the vibrations of the other strings and only showed the harmonic series of the E₄ string vibration.

### Working Example 2

### FBG Cavity Transducer

Optical pickups for an acoustic guitar and for a solid-body electric guitar were made using optical cavities consisting of two substantially identical FBGs. A temperature tunable DFB laser was used as a light source and the light reflected from the cavity was split into a photodetector using an optical circulator. The detector output was fed directly into an audio amplifier which sampled and digitized the signal before transferring it to a computer for real-time playback and storage. Alternative schemes for interrogating the FBG may be used as described above.

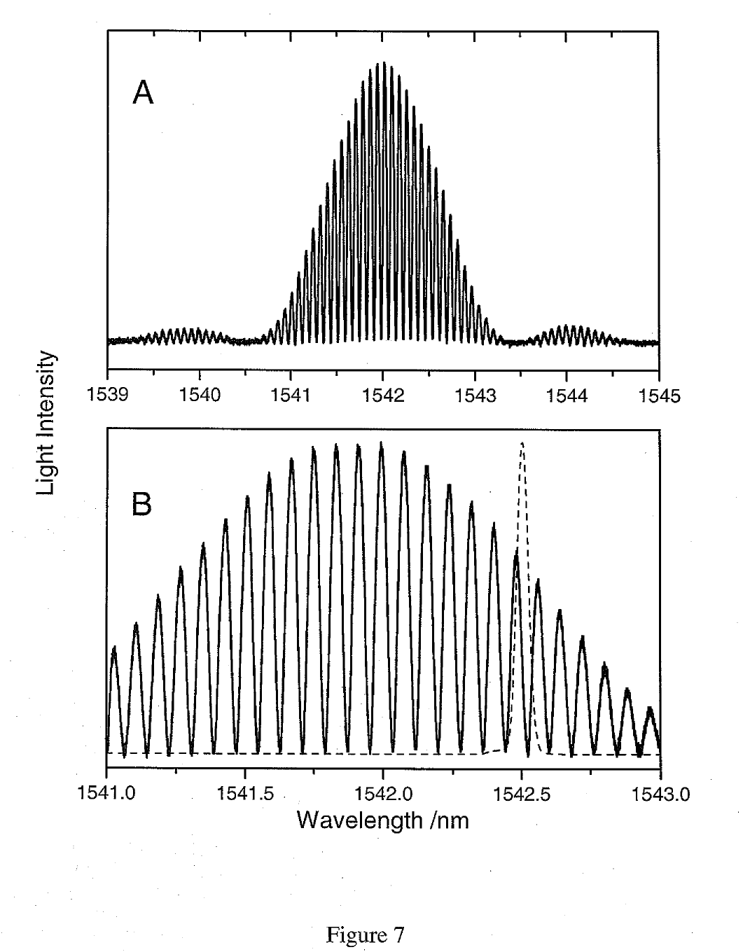

Three different FBG cavities with FBGs placed at distances of 5 mm, 10 mm, and 25 mm (QPS Photronics, Montreal, QC) were used as acoustic vibration sensors. The FBG cavities differed in their free spectral range (FSR) and in width of the cavity resonances. The FSR decreases with increasing cavity length whereas the width of the cavity resonances decreases. FIG. 1C shows a schematic drawing of the cavity and FIG. 7 shows the cavity reflectance spectrum. In both figures the envelope is formed by the reflectance spectrum of each single FBG, whereas the narrow fringes correspond to longitudinal cavity modes, at which the cavity becomes more transparent. As for the single FBG, the sensitivity of the response depended on the slope of the reflection spectrum near the midreflection point of a cavity mode and was highest for the longest cavity.

A high power DFB laser (AIFOtec butterfly laser, >95 mW/A) centered at 1542.14 nm with a linewidth of 200 MHz was used to interrogate the FBG cavities. The laser was tuned to the midreflection point of a cavity fringe near the attenuation maxima of the FBGs. The light reflected from the cavity was directed through an optical circulator (FDK, YC-1100-155) to an InGaAs photodiode detector (Thorlabs DET10C, 10 ns rise/fall time). The analog electrical photodetector signal was then amplified through a 290 kΩ series resistor and a variable terminator (Thorlabs VT1) set at 50 kΩ.

The experimental setup was substantially as shown in FIG. 1D. A dual-input (stereo) USB audio interface (Edirol UA-25EX preamplifier) with high input impedance was used to make digital recordings. The photodetector output fed into the USB interface, where it was amplified with variable gain before being digitized and transmitted to a computer (PC).

The FBG cavities were affixed to the soundboard of a hollow-body acoustic guitar (Simon and Patrick, Baie D'Uffé, Québec, S&P SC MAH) using adhesive tape. The FBG cavities were placed in different positions and recordings at these positions were compared. For this particular guitar the optimal position appeared to be at half the distance between the rim and the bridge, and with the fiberoptic cable running roughly parallel to the strings. The reflection from the cavity was recorded simultaneously on one channel of the stereo input, while the other channel recorded that of a preamplified high-quality piezoelectric (PZT) pickup built into the acoustic guitar (B-Band, A4).

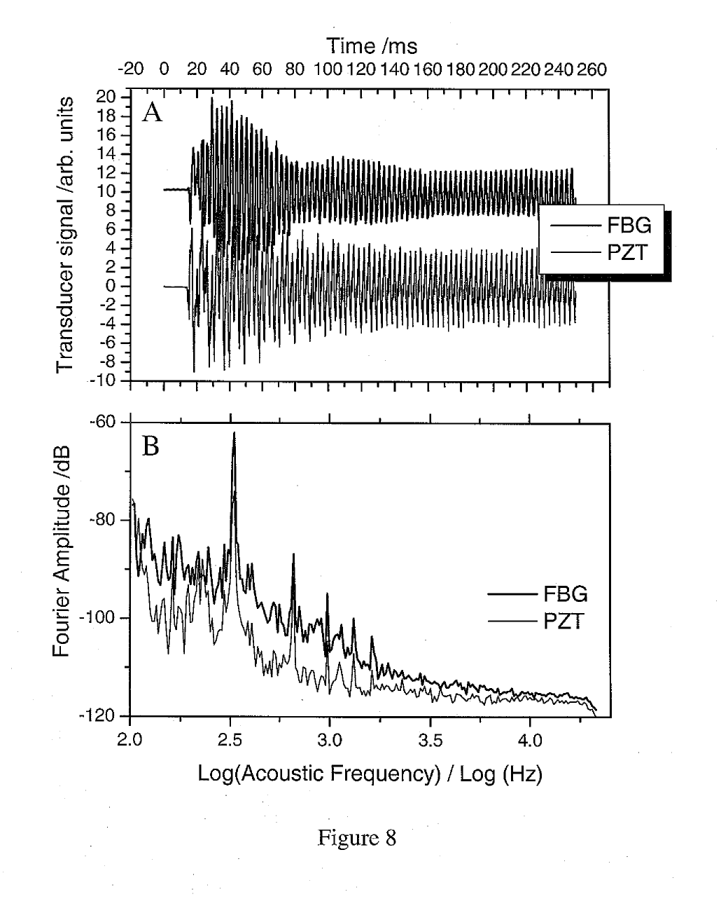

Comparison of the FBG cavity optical pickup to the piezoelectric pickup was carried out. FIG. 8A shows the amplitude spectrum of the plucked E₄ string of the acoustic guitar recorded by the FBG (lower trace) and by the PZT (upper trace) through the two different stereo channels. The traces are offset vertically for clarity. The recordings exhibit a high degree of correlation which is even more apparent when the Fourier transforms of these two recordings are compared (FIG. 8B). The frequency analysis shows a good correlation from the fundamental acoustic frequency at about 330 Hz to the 4^{th} overtone at 1650 Hz. Differences in the waveforms, particularly with regard to the relative intensities, are readily attributed to the different positions at which the PZT and FBG were placed.

### Discussion of Examples

The sensitivities of the single FBG pickup (Example 1) and of the FBG cavity pickup (Example 2) are determined by their change in attenuation/reflection at the laser interrogation wavelength. In both examples the laser wavelength was tuned to be near the mid-reflection point of the respective transducers (single FBG or FBG cavity). The attenuation near the short wavelength midreflection point changes as the FBG or the FBG cavity is strained. The attenuation changes approximately linearly with the small applied strain. The change of attenuation with strain determines the sensitivity of the transducers in this interrogation scheme. By increasing the length of the FBG the sensitivity may be increased, but the dynamic range of the strain measurement is reduced and, also, the FBG spectrum shifts increasingly with temperature changes [36]. Similarly, the sensitivity of the FBG cavity may be increased by increasing the distance between the two FBGs—again at the expense of decreased dynamic range and shift in spectrum with temperature. Such transducers designed for very high sensitivity response to strain may then become non-linear at large vibrational amplitudes and may be a source of harmonics in the sound recording. Since the harmonic content was similar for all recording devices in this example, it is believed that the measurements either do not exhibit this effect, or that the other recording methods suffer from similar non-linear responses.

It is well known that the intensity and/or wavelength of a laser diode light source, such as those used in this example, may fluctuate. In addition, the periodicity and refractive index associated with the FBG as well as the frequency spectrum of the cavity modes may also fluctuate with factors, e.g., temperature. If either of these effects cause the interrogation wavelength to drift outside the linear region around the transducer's mid-reflection point, the transducer will exhibit a reduced sensitivity to strain and also a non-linear response. Laser wavelength stabilization for FBG strain measurements may be implemented. For example, active (feedback controlled) laser wavelength stabilization may be achieved by an interferometer such as an external Fabry-Perot cavity, or—for higher accuracy—by an atomic or molecular absorption line [23]. Passive stabilization may be obtained by using a second substantially identical transducer (single FBG or FBG cavity) that provides optical feedback into the laser cavity as mentioned above.

Interrogating the transducers simply by measuring the intensity of the reflected or transmitted light at a fixed laser wavelength may also lead to errors in the dynamic strain measurement due to detector noise, laser power fluctuations and, ultimately, laser shot noise. In the optical pickup described herein, the dominant contribution to intensity noise lies in the sensitivity of the fiber cable, the optical connectors, and the other optical components to mechanical movement. The sensitivity to such intensity noise may be overcome by converting the intensity measurement into a wavelength shift measurement. For example, Gagliardi et al. described a powerful method by which the shift of a narrow band FBG was followed with a response from DC to 20 kHz [28]. The group imposed a 2.2 GHz radiofrequency modulation on the carrier signal and thereby created frequency sidebands that straddled the peak of the narrowband FBG reflection spectrum (70 pm=17.5 GHz width). Phase sensitive detection then allowed for a sensitive measurement of the strain that the FBG experienced. It was suggested in [4] that one could, in principle, track the Bragg reflection peaks using active feedback control of the laser wavelength. This feedback signal encoded the information about the FBG maximum wavelength as a function of time, which is linearly related to the desired audio signal. A second scheme involved the use of an optical cavity consisting of two identical FBGs in the same cable and locking of the laser to a cavity mode [29]. The strain measurement was carried out by feedback tracking of the cavity mode as the strain was applied to the FBG. While dynamic strain measurements of only up to 1600 Hz were carried out, the dynamic range is not fundamentally limited and may readily be extended to 20 kHz and above. Similar experiments were conducted with π-phase shifted FBGs [17,19] covering an acoustic frequency response of up to 10 MHz. Other sensitive FBG-strain sensors based on interferometric interrogation are also well-known [20, 25, 26, 27]; however, because of their susceptibility to mechanical perturbations other than the acoustic vibrations of interest, work is required to determine if this technique is suitable for use with a musical instrument.

As expected, in both examples the amplified tone varied with the position of the FBG on the instrument. This offers additional control over the sound of the instrument. When multiplexing an array of transducers by any of the methods described above and in the literature, a musician may be given a high degree of control over the sound of the instrument. For example, an array of FBGs exhibiting different reflection spectra may be interrogated with a single broadband light source and an array of optical frequency resolved detectors. Alternatively, a wavelength division multiplexing scheme may be used to interrogate the FBGs using different narrowband light source wavelengths. Finally, the output from a single narrow wavelength light source may be split into different fibers each containing an FBG. The output may then be combined in a single detector, or, for more control, into separate dedicated detectors. Such schemes may also be realized using conventional PZT pickups, but because of their comparatively high mass, an array of such pickups may distort the sound of the instrument. Note that for an array of FBG pickups, cross-talk between individual pickups is minimal.

It will be appreciated that the transducers described herein are not limited to acoustic and solid-body guitars. Rather, the technique may be readily extended to other musical instruments. Again, the small size and light weight optical interrogation of a fiber optic transducer makes possible applications that are otherwise difficult to realize with conventional pickups. For example, an optical transducer as described herein may be placed against the neck or throat of a person speaking or singing, and used to pick up acoustic vibrations originating from the vocal cords. Such pickups may also be well-suited for use with small instruments such as harmonicas, as well as instruments that are less sensitive to the added mass of a conventional pickup, such as pianos and percussion instruments. A fiber optic pickup as described herein may have a much wider range of applications compared to conventional pick-ups.

The contents of all cited publications are incorporated herein by reference in their entirety.

### EQUIVALENTS

Those of ordinary skill in the art will recognize, or be able to ascertain through routine experimentation, equivalents to the embodiments described herein. Such equivalents are within the scope of the invention and are covered by the appended claims.

### REFERENCES

1. R. Hoag, I. Kenzaburo, and K. Katsufumi, Light responsive transducer for musical instruments, Canadian Patent No. CA921738, issued Feb. 27, 1973.
2. I. C. Fotsing-Djouwe, M. Gagne, J.-J. Laurin, and R. Kashyap, Optical fibre musical instruments: Makening sense of the senseless, J. Mater. Sci.: Mater. Electron., DOI 10.1007/s10854-007-9499-7 (2007).
3. R. Kashyap, Fiber Bragg Gratings, Academic Press, Elsevier (1999).
4. N. E. Fisher, J. Surowiec, D. J. Webb, D. A. Jackson, L. R. Gavrilov, J. W. Hand, L. Zhang, and I. Bennion, In-fibre Bragg gratings for ultrasonic medical applications, Measurement Science & Technology, 8 (1997) 1050.
5. M. W. Hathaway, N. E. Fisher, D. J. Webb, C. N. Pannell, D. A. Jackson, L. R. Gavrilov, J. W. Hand, L. Zhang, and I. Bennion, Combined ultrasound and temperature sensor using a fibre Brag grating, Optics Communications, 171 (1999) 225.
6. H. Tsuda, Ultrasound and damage detection in CFRP using fiber Bragg grating sensors, Composites Science and Technology, 66 (2006) 676.
7. N. Takahashi, K. Yoshimura, S. Takahashi, and K. Imamura, Development of an optical fiber hydrophone with fiber Bragg grating, Ultrasonics, 38 (2000) 581.
8. Q. X. Yang, J. Barnes, H. P. Loock, and D. Pedersen, Time-resolved photoacoustic spectroscopy using fiber Bragg grating acoustic transducers, Optics Communications, 276 (2007) 97.
9. H. B. Zhang, S. M. Eaton, and P. R. Herman, Single-step writing of Bragg grating waveguides in fused silica with an externally modulated femtosecond fiber laser, Optics Letters, 32 (2007) 2559.
10. A. H. Nejadmalayeri, P. R. Herman, J. Burghoff, M. Will, S. Nolte, and A. Tunnermann, Inscription of optical waveguides in crystalline silicon by mid-infrared femtosecond laser pulses, Optics Letters, 30 (2005) 964.
11. W. C. Chuang, A. C. Lee, and C. T. Ho, Using a micro-molding process to fabricate polymeric wavelength filters, Optics Communications, 281 (2008) 3985.
12. D. H. Kim, W. J. Chin, S. S. Lee, S. W. Ahn, and K. D. Lee, Tunable polymeric Bragg grating filter using nanoimprint technique, Applied Physics Letters, 88 (2006)
13. A. Kocabas and A. Aydinli, Polymeric waveguide Bragg grating filter using soft lithography, Optics Express, 14 (2006) 10228.
14. S. H. Nam, J. W. Kang, and J. J. Kim, Tunable polymer waveguide Bragg filter fabricated by direct patterning of UV-curable polymer, Optics Communications, 266 (2006) 332.
15. A. M. Gillooly, H. Dobb, Z. Lin, and I. Bennion, Distributed load sensor by use of a chirped moire fiber Bragg grating, Applied Optics, 43 (2004) 6454.
16. S. C. Tjin, L. Mohanty, and N. Q. Ngo, Pressure sensing with embedded chirped fiber grating, Optics Communications, 216 (2003) 115.
17. D. Gatti, G. Galzerano, D. Janner, S. Longhi, and P. Laporta, Fiber strain sensor based on a pi-phase-shifted Bragg grating and the Pound-Drever-Hall technique, Optics Express, 16 (2008) 1945.
18. S. F. O. Silva, O. Frazao, L. A. Ferreira, F. M. Araujo, and J. L. Santos, Interrogation of a fibre Fabry-Perot interferometer using a pi-shifted Bragg grating, Measurement Science & Technology, 19 (2008)
19. M. LeBlanc, S. T. Vohra, T. E. Tsai, and E. J. Friebele, Transverse load sensing by use of pi-phase-shifted fiber Bragg gratings, Optics Letters, 24 (1999) 1091.
20. A. D. Kersey, M. A. Davis, H. J. Patrick, M. LeBlanc, K. P. Koo, C. G. Askins, M. A. Putnam, and E. J. Friebele, Fiber grating sensors, Journal of Lightwave Technology, 15 (1997) 1442.
21. N. Takahashi, K. Yoshimura, S. Takahashi, and K. Imamura, Development of an optical fiber hydrophone with fiber Bragg grating, Ultrasonics, 38 (2000) 581.
22. N. Takahashi, A. Hirose, and S. Takahashi, Underwater acoustic sensor with fiber Bragg grating, Optical Review, 4 (1997) 691.
23. A. Arie, B. Lissak, and M. Tur, Static fiber-Bragg grating strain sensing using frequency-locked lasers, Journal of Lightwave Technology, 17 (1999)
24. A. Cusano, A. Cutolo, J. Nasser, M. Giordano, and A. Calabro, Dynamic strain measurements by fibre Bragg grating sensor, Sensors and Actuators A—Physical, 110 (2004)
25. A. D. Kersey, T. A. Berkoff, and W. W. Morey, Fiberoptic Bragg Grating Strain Sensor with Drift-Compensated High-Resolution Interferometric Wavelength-Shift Detection, Optics Letters, 18 (1993) 72.
26. A. D. Kersey, T. A. Berkoff, and W. W. Morey, High-Resolution Fiber-Grating Based Strain Sensor with Interferometric Wavelength-Shift Detection, Electronics Letters, 28 (1992) 236.
27. K. P. Koo and A. D. Kersey, Bragg grating-based laser sensors systems with interferometric interrogation and wavelength-division multiplexing, Journal of Lightwave Technology, 13 (1995) 1243.
28. G. Gagliardi, M. Salza, P. Ferraro, and P. De Natale, Fiber Bragg-grating strain sensor interrogation using laser radio-frequency modulation, Optics Express, 13 (2005)
29. G. Gagliardi, M. Salza, P. Ferraro, and P. De Natale, Interrogation of FBG-based strain sensors by means of laser radio-frequency modulation techniques, Journal of Optics A—Pure and Applied Optics, 8 (2006) 5507.
30. J. R. Lee, S. S. Lee, and D. J. Yoon, Simultaneous multipoint acoustic emission sensing using fibre acoustic wave grating sensors with identical spectrum, Journal of Optics A—Pure and Applied Optics, 10 (2008)
31. H. J. Bang, S. M. Jun, and C. G. Kim, Stabilized. interrogation and multiplexing techniques for fibre Bragg grating vibration sensors, Measurement Science & Technology, 16 (2005) 813.
32. A. Hongo, S. Kojima, and S. Komatsuzaki, Applications of fiber Bragg grating sensors and high-speed interrogation techniques, Structural Control & Health Monitoring, 12 (2005)
33. D. C. Betz, G. Thursby, B. Culshaw, and W. J. Staszewski, Acousto-ultrasonic sensing using fiber Bragg gratings, Smart Materials & Structures, 12 (2003) 122.
34. M. Gupta, H. Jiao, and A. O'Keefe, Cavity-enhanced spectroscopy in optical fibers, Optics Letters, 27 (2002) 1878.
35. M. Andachi, T. Nakayama, M. Kawasaki, S. Kurokawa, and Ti P. Loock, Fiber-optic ring-down spectroscopy using a tunable picosecond gain-switched diode laser, Applied Physics B—Lasers and Optics, 88 (2007) 131.
36. J. R. Lee and H. Tsuda, A novel, fiber Bragg grating acoustic emission sensor head for mechanical tests, Scripta Materialia, 53 (2005)
37. S. Baek, Y. Jeong, and B. Lee, Characteristics of short-period blazed fiber Bragg gratings for use as macro-bending sensors, Applied Optics, 41 (2002) 631-636.

1. An optical pickup for a musical instrument, comprising:
at least one Bragg grating in physical contact with a vibrating structure of the musical instrument so as to receive acoustic vibration associated with the musical instrument being played;
wherein a spectrum of the Bragg grating is modulated upon receipt of the acoustic vibration.

2. The optical pickup of claim 1, wherein the at least one Bragg grating has a grating selected from constant pitch, chirped, blazed, and π-shifted.

3. The optical pickup of claim 1, wherein the Bragg grating is disposed in an optical fiber.

4. The optical pickup of claim 3, wherein the optical fiber is a single mode optical fiber.

5. The optical pickup of claim 1, comprising two or more Bragg gratings.

6. The optical pickup of claim 5, wherein a response from at least one Bragg grating is biased optically and/or electronically.

7. The optical pickup of claim 1, comprising two Bragg gratings arranged as an optical cavity.

8. The optical pickup of claim 7, wherein the two Bragg gratings are substantially identical.

9. An optical pickup system for a musical instrument, comprising:
at least one Bragg grating in physical contact with a vibrating structure of the musical instrument so as to receive acoustic vibration associated with the musical instrument being played;
a light source that produces light for use with the Bragg grating; and
means for detecting modulation of a spectrum of the light by the Bragg grating upon receipt of the acoustic vibration.

10. The system of claim 9, wherein the at least one Bragg grating has a grating selected from constant pitch, chirped, blazed, and π-shifted.

11. The system of claim 9, wherein the means for detecting modulation of a spectrum of the light by the Bragg grating measures at least one of intensity of reflected or transmitted light at a fixed wavelength, and shift of the peak reflection wavelength.

12. The system of claim 9, wherein the means for detecting modulation of a spectrum of the Bragg grating is a photodetector.

13. The system of claim 9, comprising two or more Bragg gratings.

14. The system of claim 13, wherein a response from at least one Bragg grating is biased optically and/or electronically.

15. The system of claim 13, wherein the two or more Bragg gratings are interrogated sequentially.

16. The system of claim 13, wherein the two or more Bragg gratings are interrogated simultaneously.

17. The system of claim 11, wherein the at least one Bragg grating is disposed in an optical fiber.

18. The system of claim 17, wherein the optical fiber is a single mode optical fiber.

19. The system of claim 11, comprising two Bragg gratings arranged as an optical cavity.

20. The system of claim 19, wherein the two Bragg are substantially identical.

21. A method for an optical pickup for a musical instrument, comprising:
disposing at least one Bragg grating in physical contact with a vibrating structure of the musical instrument so as to receive acoustic vibration associated with the musical instrument being played;
launching light into the Bragg grating; and
detecting modulation of a spectrum of the light by the Bragg grating upon receipt of the acoustic vibration.

22. The method of claim 21, wherein the at least one Bragg grating has a grating selected from constant pitch, chirped, blazed, and π-shifted.

23. The method of claim 21, comprising disposing two or more Bragg gratings on the musical instrument.

24. The method of claim 23, further comprising manipulating a response from at least one Bragg grating through electronic and/or optical biasing.

25. The method of claim 21, wherein detecting comprises detecting at least one of intensity of reflected (or transmitted) light at a fixed wavelength, and shift of the peak reflection wavelength.

26. The method of claim 21, wherein detecting comprises using a photodetector.

27. The method of claim 23, further comprising interrogating the two or more Bragg gratings sequentially.

28. The method of claim 23, further comprising interrogating the two or more Bragg gratings simultaneously.

29. The method of claim 21, comprising disposing the at least one Bragg grating in an optical fiber.

30. The method of claim 21, comprising disposing the at least one Bragg grating in a single mode optical fiber.

31. The method of claim 21, comprising disposing two Bragg gratings arranged as an optical cavity.

32. The method of claim 21, comprising disposing two substantially identical Bragg gratings arranged as an optical cavity.
